(19) United States
(12) Patent Application Publication
(10) Pub. No.: US 2025/0300258 A1
(43) Pub. Date: Sep. 25, 2025

(54) BATTERY FRACTIONATION UNIT AND BATTERY FRACTIONATION METHOD

(71) Applicant: REGAIN Sp. z o.o., Wejherowo (PL)

(72) Inventors: Jan HUPKA, Gdansk (PL); Lukasz HUPKA, Reda (PL)

(21) Appl. No.: 18/725,660

(22) PCT Filed: Dec. 12, 2022
(86) PCT No.: PCT/PL2022/000071

§ 371 Date: Jun. 28, 2024

(30) Foreign Application Priority Data
Dec. 30, 2021 (PL) P.440038

(51) Int. Cl. H01M 10/54

(52) U.S. Cl. CPC H01M 10/54

(57) ABSTRACT

A battery fractionation unit has a battery container, a chute supplying batteries, and a chute supplying dry ice granules to the container. Cooled batteries from the container are supplied to a working chamber of a cutting unit. The crushed batteries from the cutting unit are supplied to an impact mill. The milled materials from the impact mill are supplied to a vibrating sieve chamber equipped with a pneumatic separator unit for separating the plastic fraction of the batteries. The battery container has a hot chamber for initial battery cooling in a gaseous CO₂ atmosphere and a cold chamber for dosing dry ice granules to the cooled batteries. The container has a chute dosing the mixture of dry ice and batteries that is supplied to the cutting unit.

### CROSS-REFERENCE TO RELATED APPLICATIONS

The present application is a 35 U.S.C. §§ 371 national stage application of International Application No. PCT/PL2022/000071, filed Dec. 12, 2022, which claims priority to Polish Patent Application No. P.440038, filed Dec. 30, 2021, the contents of which are incorporated herein by reference.

### FILED OF INVENTION

The object of the invention is a battery fractionation unit and a battery fractionation method. The battery should be understood in this patent disclosure as all types of commonly used batteries and cells with high energy density, in particular used lithium-ion cells comprising waste. Fractionation should be understood in this patent disclosure as separation of the entire material of used batteries into fractions separated to a degree enabling such fractions to be subjected to chemical, physico-chemical or hydrometallurgical processes.

### BACKGROUND

Some used batteries, such as for example LPF-lithium iron phosphate batteries, are regenerated without disrupting the structure of individual cells. Material recycling, however, involves separation and physico-mechanical and chemical recovery of the ingredients and their use in production of new batteries. The initial battery capacity is partially restored during the regeneration process. However, after one or more regeneration cycles, batteries can also be disposed of through separation, fractionation and component recovery, similar to used batteries which were not subjected to regeneration.

Deficit raw materials, such as lithium, cobalt, nickel and manganese are used to produce batteries with high energy density, using a range of known technologies recovering such materials from cells no longer suitable for use. The example recycling process of lithium-ion batteries begins with their disassembly into individual cells, followed by separation. Separation of ferrous materials is another solution used in material recovery technologies. The next stage is the separation of the electrolyte solution and of other raw materials, including the use of chemical processing. As liquid electrolyte, for example, solutions of lithium sulphate Li₂SO₄, lithium hexafluorophosphate LiPF₆ or lithium perchlorate LiClO₄ are used and are for example dissolved in a mixture containing various ratios of ethylene, diethyl, dimethyl and propylene.

These processes, however, must be preceded with battery fractionation into particles which may be subjected to further chemical or metallurgical processes. The object of the invention includes a battery fractionation unit and a battery fractionation method used within a recycling procedure. The invention is related to an unit and a method of used battery fractionation and is focussed on obtaining fractions suitable for further chemical or physico-chemical processes.

A battery should be understood in this patent disclosure as the basic unit intended for energy storage, including electrodes, a separating element and electrolyte. In the case of cells using solid electrolyte, the electrolyte itself separates the anode and the cathode, eliminating the need to use a separating element. The basic batteries are usually combined into units, however, said batteries are often marketed separately and have cylindrical, flat shape or are formed as circular discs. Such batteries are used as a power supply source for equipment and instruments, e.g. medical equipment, electrical motors in vehicles, vessels or in laptops, smartphones, power tools, remote control units and other commonly used devices. They are often offered as rechargeable batteries. Their best before date is very long and they last for years. They become waste hazardous to the environment at the end of their useful lifetime.

An example lithium-ion cell may have various shapes, however, it is usually offered as a cylindrical cell with a diameter of 18 mm and 65 mm long, known as the 18650 cell or with a diameter of 21 mm and 70 mm long, known as the 2170 cell. Such cells reach the capacity of ca. 3,000 mAh to 6,000 mAh, however, the current they are able to generate is different and depends on their design. Cells with lithium-cobalt chemistry are the most common, however, manganese or nickel in various qualitative and quantitative compositions may be used in addition to cobalt. In this background, disposal of batteries with high energy densities becomes a technological challenge.

A range of solutions for the execution of the disposal process for recovery of materials for re-use in the same technological process of cell production or in other technological processes are known. The initial stage includes mechanical fractionation of batteries with separation into the basic components of cells. The first stage of fractionation usually is cell crushing in mills. Cooled cells are fed to the crushing device, wherein liquid nitrogen or carbon dioxide as dry ice are usually used in the cooling process. Adequate battery cooling before crushing causes the electrode material of the cells to solidify.

Because of the structure and chemical composition of cells with high energy density, they must be subjected to initial processing before the recovery of valuable raw materials for re-processing. The initial processing usually involves battery discharging, sorting, segregation, disassembly and separation from the package and preceded by fractionation of cell components, such as anode, cathode, separating element, electrolyte or binder. The basic unit operations include: battery separation through cutting and crushing and sieving of the crushed material. Because of the presence of toxic components, a range of hazards related to the execution of such processes in batteries with high energy density exists. These hazards are the consequence of the toxicity of battery components, the violent nature of some possible chemical and electrochemical reactions, flammability and thus—from the susceptibility of some components to self-ignition.

The recycling process known from the patent disclosure U.S. Pat. No. 7,169,296 proposes a disposal technology based on pyrolysis. This known solution proposes a melting stage, during which metals are obtained as an alloy of cobalt, copper, nickel and iron. Other valuable metals, such as lithium, manganese and aluminium, are not recovered. A process according to this known solution requires significant amounts of heat and an advanced system for purification of toxic flue gases.

In a solution known from the Chinese patent document CN 108525817, a crushing device for used lithium-ion batteries operating at low temperature was disclosed at the fractionation stage. This device includes a low-temperature freezing unit, a crushing unit and an unloading unit, the low-temperature freezing unit contains a liquid nitrogen tank, a solenoid valve, a freezing container and a sealing plate. Used lithium-ion batteries are frozen in the freezing container, at low temperature. The device enables freezing of used lithium-ion batteries before crushing in order to deactivate them and crush the batteries under a cover of liquid nitrogen. Nitrogen also facilitates extinguishing of the materials if self-ignition occurs during discharging. This is followed by fractionation.

Another solution known from the patent document CN 108777332 discloses the processing of used lithium-ion batteries using dry ice. This method involves the following stages: cooling and freezing a lithium-ion battery using dry ice sublimation, followed by crushing and physical sorting of the crushed materials. Dry ice, which is not used during cooling, is recycled and re-used, and gaseous carbon dioxide absorbing heat intended for sublimation is also recycled. Gaseous carbon dioxide is compressed again to liquid CO₂, followed by dry ice for re-use. According to this known solution, the cells are initially cooled using dry ice, and the cooled cells are subsequently sent to the chamber of the crushing device.

Another known solution is presented in the patent disclosure CH 681401. According to this solution, the cells are separated according to their size during the first stage. The cells are cooled to −100° C. to −190° C. using liquid nitrogen or other liquefied gases. At these temperatures, the cells are brittle and are easier to separated. After the initial separation, the cells are further separated and divided into fractions. One fraction contains covers or coatings, another fraction contains the interior of the cells. The cover fraction is separated magnetically into magnetic scrap and a non-magnetic fraction, including plastics. The other part includes non-magnetic scrap containing zinc, molybdenum, copper and lead. This is followed by the next step, dissolution in sulphuric acid. Substances soluble in sulphuric acid enter the solution, while the residue contains insoluble substances. Manganese (Mn²⁺), nickel (Ni²⁺), zinc (Zn²⁺), cadmium (Cd²⁺), mercury (Hg²⁺), lithium (Li⁺), potassium (K⁺) and sodium (Na⁺) in the ion form become dissolved. The residue contains carbon, partially as graphite, manganese dioxide (MnO₂), silicon dioxide (SiO₂), aluminium trioxide (Al₂O₃) and compounds of cadmium, mercury, copper and lead. Individual elements are separated from the sulphuric acid solution using selective ion exchangers. The obtained eluate is electrolysed. Manganese separates on the anode, while the other metals-on the cathode. Sulphuric acid is regenerated. The residue insoluble in sulphuric acid is dissolved in nitric acid, wherein the residue is separated by gravity and divided into three fractions. The first fraction contains manganese dioxide, the second fraction contains carbon, partially as graphite, while the third fraction contains silicon dioxide (SiO₂) and aluminium trioxide (Al₂O₃). Nitric acid is regenerated.

Another solution known from the international application WO 2020/145829 discloses a separation method for galvanic cells with high energy densities, characterised in that a mixture of used cells is placed inside an insulated container and carbon dioxide a dry ice is added to said container as a cooling agent. Dry ice is added to the mixture of used galvanic cells in the volumetric ratio of 0.5:1 to 2:1, and the mixture of used cells with dry ice is set at −20° C. to −50° C., and the mixture of used cells with dry ice is subsequently fed to a crushing device and subjected to separation. Dry ice is preferably available as granulated ice with granule size of 14 mm to 18 mm. A stream of used galvanic cells and a stream of dry ice granules are preferably fed simultaneously to the insulated container of the crushing device. Once the crushing of galvanic cells is finished, the mixture of air and gaseous carbon dioxide is returned to the insulated container of the crushing device. This solution proposes introduction of cooled cells with dry ice granules to the chamber of the crushing device.

### SUMMARY

The objective of the invention is to solve the problem of obtaining electrode material without a loss of electrode mass components, as well as of the ferromagnetic fraction, the non-ferrous metal fraction and the polymer fraction in an environment-friendly manner, such that complete re-circulation of all battery components is possible during the next stage.

According to the invention, the battery fractionation unit contains a battery container with a temperature measurement function and a gaseous phase composition measurement function, with a battery feeding chute and a dry ice granule feeding chute to this container, where the outlet of cooled batteries from the container is located at the working chamber of the cutting device, while the outlet of the crushed batteries from the cutting device is connected to the inlet to an impact mill, containing a pneumatic separator unit. The outlet chute of the milled material from the impact mill is connected to a vibrating sieve chamber equipped with a pneumatic separator unit for separation of the plastic fraction present in the battery housings. The vibrating sieve chamber contains the upper sieve and the lower sieve, under which the tray for the sieved material is located and where the upper sieve is additionally equipped with a magnetic separator I, while the bottom sieve is equipped with a magnetic separator II and both magnetic separators separate magnetic parts from the sieved materials on the sieves.

The unit according to the invention is characterised in that the battery container contains a hot chamber for initial battery cooling in a gaseous CO₂ atmosphere and a cold container for dry ice granule dosing to the initially cooled batteries, wherein the container includes a dosing chute for the mixture of dry ice with batteries to the cutting device, where the outlet of the chute accepting crushed batteries with dry ice from the cutting device is located in the chamber of the impact mill, while the outlet of the chute for the milled material from the impact mill is located inside the chamber of the vibrating sieves unit. The upper sieve chamber contains a built-in air intake and outlet of the pneumatic separator, while the bottom sieve contains the magnetic separator I unit, while the tray for the sieved material contains the magnetic separator II unit. The outlet of material from the bottom sieve is connected to the non-ferrous metal container, while the outlet of material from the tray of the sieved material is connected to the inlet of the electrode material to the storage container, wherein the chute of the magnetic material is connected to the inlet chute to the storage container for the ferromagnetic material.

In the preferable embodiment of the solution according to the invention, the cutting device has two rows of known, meshing cutting knives, 7 mm to 12 mm wide.

According to the invention, the battery fractionation method with high energy density is characterised in that the batteries are segregated according to their physico-chemical properties and then transferred to the battery container, where batteries are cooled using gaseous CO₂ in the hot chamber of the container, while cooling using dry ice is performed in the cold chamber of the container and once the batteries reach temperatures below −34° C. they are crushed and subjected to pneumatic separation of particles of the polymer fraction and magnetic separation of battery housing parts, the milled material is sieved in the vibrating sieve chamber and electrode powder is collected for further processing.

According to the invention, the battery fractionation method is characterised in that the batteries are cooled in a CO₂ in the hot chamber of the container, to which gaseous CO₂ from the circulation is returned, and then the initially cooled batteries are transferred to the cold chamber of the container, to which the chute simultaneously supplies dry ice granules, wherein the storage time of cells in the cold chamber with dry ice granules is at least 10 minutes, wherein dry ice granules with diameter of 3 mm to 16 mm are fed to the cold chamber, while batteries are cut with added dry ice granules during the first stage of separation into 7 to 12 mm slices. The cooled material from the first separation stage, cut into slices and mixed with dry ice, is further separated in the second stage of separation in an impact mill, wherein pneumatic separation of plastic particles takes place inside the impact mill, wherein the separation in the impact mill is performed together with dry ice particles and the milled material is obtained as a mixture of electrode material particles and film present in the batteries, while gaseous CO₂ is returned to the hot chamber of the battery container. The material obtained during separation inside the impact mill with pneumatic separation of plastics is fed to the vibrating sieve chamber, where the material separated on the upper sieve, with a size >5 mm and preferably at temperature −35° C. is separated pneumatically, removing parts of polymer materials, while the residue is transferred to the magnetic separator I, where magnetic metal parts are separated and the sieved material with the size of >1 mm from the bottom sieve is also transferred to the magnetic separator I, where magnetic particles are separated again from the residue comprising electrode material, containing cathode and anode powder with electrolyte, solidified at this temperature.

In the solution according to the invention, batteries and dry ice granules with diameter of 3 mm to 16 mm are fed simultaneously to the cold chamber, wherein the cutting unit cuts the mixture of batteries and added dry ice granules into slices, 7 to 12 mm thick.

The rotation speed of shafts of the cutting unit with meshing knives in this device is preferably set at 7 to 13 rotations/minute.

On the other hand, the rotation speed of the impact mill is preferably used within the range of 1,000 to 2,000 rotations/minute.

The solution according to the invention proposes a technological application of a friendly cooling agent in the form of carbon dioxide used as dry ice. Material separation aimed at the release of the component fractions was proposed, thanks to which the fractions are prepared for mechanical and physico-chemical separation in a single step. The process preferably takes place at temperatures below −35° C., which enables the adequate solidification and brittleness of the electrode material to be achieved, while preventing solvent losses and emissions to the environment. The performance of the separation process in cutting and impact mills at temperatures decreased to below −35° C., in the presence of dry ice, limits the wear of working blades, while it prevents the accumulation of deposits on the crushing, sieving and separating units. The related reduction of project costs is ca. 20% in this case.

Contrary to solutions known in the art and aimed at raw material recycling, including pyrometallurgy and hydrometallurgy solutions, the technology according to the invention comprises direct material recycling. The use of battery materials according to the invention in direct recycling allows the battery production cost to be decreased by 15% to 25%. The solution allowed energy consumption to be decreased by ca. 30%. The carbon footprint was decreased 2.5 times, counting as g/kg of batteries, compared to the pyrometallurgic method and 1.4 times compared to the hydrometallurgic method.

This solution is an innovative technology of materials available in deficit quantities in Poland and in the EU. Poland imports nearly 100% of trace elements of the cathode material used in battery production, according to National Raw Materials Policy, Ministry of Environment, Warsaw 2018, ISBN 978-83-7863-778-3). Lithium oxide and hydroxide are 100% imported, and their consumption is estimated at approximately 100 tonnes. Lithium carbonate is also 100% imported, and its consumption is ca. 150 tonnes. Cobalt is 100% imported, consumption is ca. 30 tonnes. Aluminium is 94.2% imported, consumption is ca. 140 thousand tonnes. These materials are in deep deficit in the EU as a whole, according to the Report of the European Commission, Brussels, 22 Nov. 2018 SWD (2018) 245/2.

The process according to the invention may be implemented in a mobile unit, which may be installed on a platform or transported and placed at waste collection points, for example, at General Waste Selective Collection Points (PSZOK). The solution enables a compact, modular design. The dimensions of a single module are 3.5 m×2 m×2 m (L×H×W) and such a module can be installed inside a typical container.

The process is used with optimal cooling of the processed material and energy efficient separation method, thus effectively preventing pollutant emissions. The use of carbon dioxide as dry ice sublimating to the gaseous form in a closed circuit eliminates the risk of self-ignition. Fractions of intermediate products have also been obtained for their further refining aimed at full recovery of materials with quality similar to materials used in production of new batteries.

### BRIEF DESCRIPTION OF THE FIGURES

The object of the invention is presented in an embodiment in the attached drawing, in which individual figures of the drawing represent as follows:

FIG. 1—a diagram of the battery fractioning unit,

FIG. 2—a diagram of the technological process for battery fractioning,

FIGS. 3A-3D—four material fractions obtained with a process according to the present invention.

### DETAILED DESCRIPTION

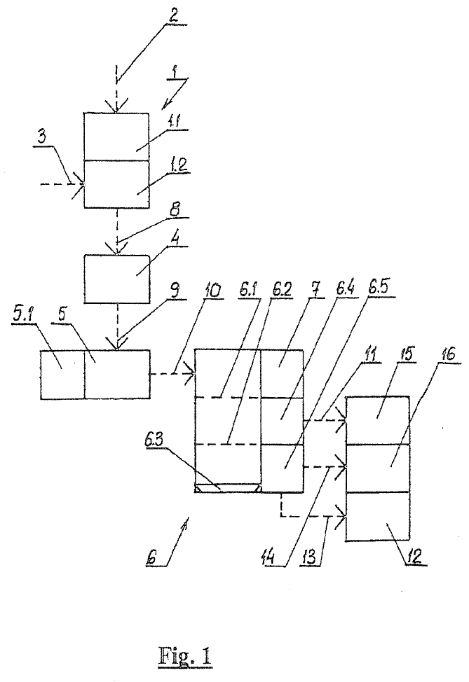

FIG. 1 schematically presents a diagram of a battery fractioning unit. The unit includes a batter container 1 with a known temperature measurement and a schematically shown chute 2 supplying batteries to the hot chamber 1.1 of the container 1. Gaseous carbon dioxide CO₂ formed after sublimation of dry ice granules during battery fractioning is supplied to the hot chamber 1.1 of the container 1 using a line. Batteries are initially cooled in the hot chamber to approximately 0° C. The hot chamber 1.1 of the container 1 is connected to the cold chamber 1.2 of this container 1, as shown schematically in FIG. 1. This FIG. shows that the chamber 1.2 contains the chute 3 supplying dry ice granules to the container 1. The chute outlet 8 for the mixture of cooled batteries from the container 1 together with dry ice granules is located inside the working chamber of the cutting unit 4. In the known cutting unit 4, known in the art as multi-shaft separator, the mixture of batteries and dry ice granules SL is cut into slices. In a preferred embodiment of the solution according to the invention, the cutting unit 4 has two rows of known, meshing cutting knives with the width of up to 10 mm.

The outlet for crushed batteries from the cutting unit 4 is connected to the inlet 9 to the impact mill 5. The impact mill 5 is a known hammer-type mill enabling adjustment of material separation degree using rotation speed adjustment. FIG. 1 shows that the impact mill 5 contains a pneumatic separator unit 5.1, which is a known unit supplying and collecting carbon dioxide with the collection part on the sieve for light materials, such as paper or plastics present in the batteries.

The outlet chute 10 of the milled material from the impact mill 5 is connected to the vibrating sieve chamber 6 equipped with another pneumatic separator unit 7 for separation of the plastic fractions present in the battery housings. The vibrating sieve chamber 6 contains the upper sieve 6.1 and the lower sieve 6.2, under which the tray for the sieved material 6.3 is located. The upper sieve 6.1 is additionally equipped with the magnetic separator I designed as 6.4, while the lower sieve 6.2 is equipped with the magnetic separator II designed as 6.5. Both known magnetic separators 6.4, 6.5 separate magnetic particles from the sieved material on sieves 6.1, 6.2.

The chute outlet 10 from the impact mill 5 is located inside the chamber 6 of the vibrating sieve unit. The upper sieve 6.1 chamber includes a built-in intake line and an outlet line of another known pneumatic separator 7. The outlet 11 of material from the bottom sieve 6.2 is connected to the non-ferrous metal container 15, while the outlet of material from the tray of the sieved material 6.3 is connected to the inlet 13 of the electrode material to the storage container 12, wherein the chute 14 of the magnetic material is connected to the inlet chute to the storage container 16 for the ferromagnetic material. FIG. 1 presents the container 15 collecting the non-ferrous metal fraction, the container 16 collecting the ferromagnetic material fraction and the container 12 collecting the electrode material fraction.

In a preferred embodiment of the solution according to the invention, the cutting unit 4 has two rows of known, meshing cutting knives, 7 mm to 12 mm wide.

The individual modules: battery cooling, crushing, separation and sieve enrichment, separation and magnetic enrichment cooperate and are an integral part of the unit. The modules are permanently fixed to the platform and integrated, interconnected using known band and screw conveyors.

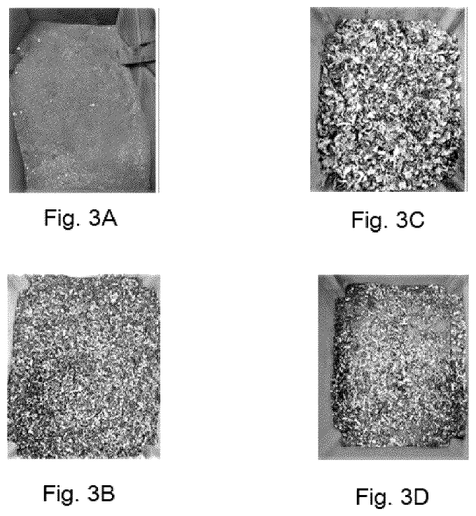

FIG. 3A (Fraction 1) shows electrode powder from the tray for the sieved material 6.3.

FIG. 3B (Fraction 2) shows Cu and Al film in the size of 0.5 mm to 5 mm from the non-ferrous metal container 15.

FIG. 3C (Fraction 3) shows plastics in the size >5 mm from battery housings and membranes from the pneumatic separator 7.

FIG. 3D (Fraction 4) shows ferromagnetic material in the size of 0.5 mm to 5 mm from the container 16.

The most valuable material is the electrode powder containing compounds of Co, Ni, Li, C, Mn, comprising fraction 1.

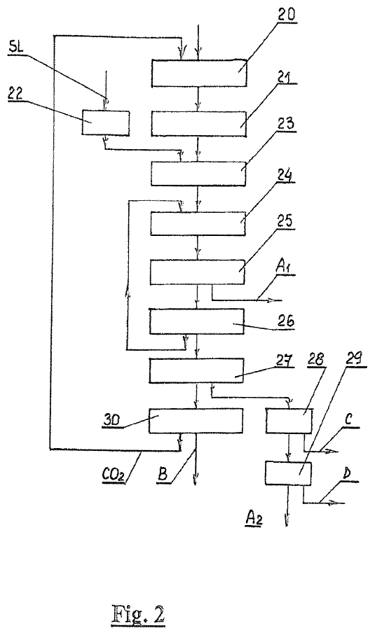

FIG. 2 shows an embodiment battery fractionation method for batteries with high energy densities. In this embodiment, the solution involves battery sorting according to their physico-chemical composition and this stage is followed by the transfer of the segregated battery types to the battery container 1, where the batteries are cooled using gaseous CO₂ from the process circuit, in the hot chamber 1.1 of the container 1, to 0° C., followed by further cooling of the batteries in the cold chamber 1.2 using dry ice. Once the mixture of batteries and dry ice reach −35° C., the batteries are crushed with dry ice, subjected to pneumatic and magnetic separation of particles and the material is sieved in the vibrating sieve chamber and the electrolyte solution and the cathode and anode materials are recovered.

In this embodiment, batteries in the container 1 are cooled in a CO₂ atmosphere in the hot chamber 1.1 of the container 1, to which gaseous CO₂ is returned from the circuit, followed by the transfer of the initially cooled batteries to the cold chamber 1.2 of the container 2, where dry ice granules are simultaneously supplied via the chute 3. The duration of battery storage inside the cold chamber 1.2 with dry ice granules SL is at least 10 min, wherein dry ice granules with the diameter of 3 mm to 16 mm are supplied to the cold chamber 1.2.

During the first stage of crushing, the batteries with added dry ice granules are cut into slices, 7 to 12 mm thick, inside the cutting unit 4. The cooled material from the first crushing stage, cut into slices and in the mixture with dry ice SL, is further crushed during the second crushing stage inside an impact mill 5, wherein pneumatic separation of plastic particles takes place simultaneously inside the impact mill 5. The crushing inside the impact mill 5 is performed using dry ice particles. The milled material from this stage of the process is obtained as a mixture of electrode material particles and the separating film from the batteries, while gaseous CO₂ is returned to the hot chamber 1.1 of the battery container 1.

The material obtained during crushing in the impact mill 5 with pneumatic separation of plastics is fed to the vibrating sieve chamber 6, where the upper sieve 6.1 retains the fraction of particles larger than 5 mm at a temperature not higher than 0° C. and this fraction is subjected to pneumatic separation 7 separating plastic particles. The residue is then transferred to the magnetic separator I designated in FIG. 1 as 6.4, where magnetic metal parts are separated. The sieved material from the bottom sieve 6.2, where the retained fraction contains material with the size of 1 mm to 5 mm, is also transferred to the magnetic separator I designated as 6.4. Here, magnetic particles are separated from the rest of the material containing non-magnetic cathode material particles together with the electrolyte solution. Batteries and dry ice granules with diameter of 3 mm to 16 mm are fed simultaneously to the cold chamber 1.2 of the battery container 1, wherein the cutting unit 4 with the design of a multi-shaft separator cuts the mixture of batteries and added dry ice granules into slices, 7 to 12 mm thick. The rotation speed of shafts of the cutting unit 4 with meshing knives in this device is preferably set at 10 rotations/minute. The crushed batteries mixed with crushed dry ice granules are then fed to the impact mill 5. In this embodiment, the impact mill 5 is a known hammer-type mill. The rotation speed of the knives of the impact mill 5 is 1,500 rotations/minute in this embodiment.

The course of technological processes in the example embodiment is shown in the block diagram in FIG. 2. After battery storage 20 in the container 1, battery dosing 21 with dry ice SL dosing 22 for the purpose of crushing I designated in FIG. 2 as 23 in the cutting unit 4 are performed. Crushing I takes place at a temperature below −45° C. The obtained mixture is transferred to crushing II designated as 24, where the second stage of crushing takes place below −45° C. The crushed material is separated pneumatically in the process 25 for collection of light polymers A₁. The residue is subjected to sieving I designated as 26 in FIG. 2, followed by sieving II designated in FIG. 2 as 27. During sieving II designated as 27, magnetic separation 28 is performed in order to recover the fraction of ferrous materials C. The non-ferrous material fraction D is collected on the collection tray 6.3. Heavy polymers A₂ are removed simultaneously. The sieved material from sieve II, comprising the electrode powder for further processing, is simultaneously collected for storage 30.

### LIST OF REFERENCES USED IN THE FIGURES

1. Battery container
1.1. Hot chamber
1.2. Cold chamber
2. Battery supplying chute
3. Dry ice supplying chute
4. Cutting unit
5. Impact mill
5.1. Pneumatic separator
6. Vibrating sieve chamber
6.1. Upper sieve
6.2. Lower sieve
6.3. Tray for the sieved material
6.4. Magnetic separator
6.5. Magnetic separator II
7. Pneumatic separator
8. Chute for the mixture of batteries and dry ice
9. Chute collecting material from the cutting unit
10. Chute for the milled material
11. Outlet collecting material from the bottom sieve
12. Flotation tank for the anode material
13. Outlet of the sieved anode material
14. Chute for the electrolyte and cathode material
15. Container for non-ferrous metals Cu, Al
16. Container for the electrolyte and cathode material
20. Battery storage
21. Battery dosing
22. Dry ice dosing
23. Crushing I (<−45° C.)
24. Crushing II (<−40° C.)
25. Pneumatic separation
26. Sieving I (<−35° C.)
27. Sieving II (<−35° C.)
28. Magnetic separation
29. Eddy current sedimentation
30. Storage (<−40° C.)
A₁. Light polymers
A₂. Heavy polymers
B. Electrode powder
C. Ferrous materials
D. Non-ferrous materials
SL. Dry ice
CO₂. Gaseous carbon dioxide

1. A battery fractionation unit containing a battery container with measurements of temperature and of the gaseous phase composition and with a chute supplying batteries and with a chute supplying dry ice granules to the container, wherein the outlet of cooled batteries from the container is located inside the working chamber of the cutting unit, while the outlet of crushed batteries from the cutting unit is connected to the inlet to the impact mill containing the pneumatic separator unit, wherein the outlet chute of the milled material from the impact mill is connected to the vibrating sieve chamber, equipped with a pneumatic separator unit for separation of the fraction of plastics present in battery housings, while the vibrating sieve chamber contains the upper sieve and the lower sieve, under which the tray for the sieved material is located, together with temperature and gaseous phase composition sensors, wherein the battery container contains a hot chamber for initial battery cooling in the gaseous CO₂ atmosphere and a cold chamber for dosing dry ice granules to initially cooled batteries, wherein the container contains a chute dosing the mixture of dry ice granules and batteries to the cutting unit, where the outlet of the chute collecting crushed batteries with dry ice from the cutting unit is located inside the chamber of the impact mill, while the outlet of the chute for the milled material from the impact mill is located inside the vibrating sieve unit chamber, wherein the top sieve chamber contains a built-in intake and outlet line of the pneumatic separator, while the bottom sieve contains the magnetic separator I unit, while the tray for the sieved material contains the magnetic separator unit II, wherein the outlet collecting material from the bottom sieve is connected to the non-ferrous metal container, while the material outlet from the tray of the sieved material is connected to the inlet of the material to the storage container of the electrode material for further processing, while the chute for the magnetic material is connected to the inlet chute to the storage container for the ferromagnetic material.

2. A battery fractionation unit according to claim 1, wherein that the cutting unit has two rows of meshing cutting knives, 7 mm to 12 mm wide.

3. A battery fractioning method for batteries with high energy density, wherein the batteries are segregated according to their physico-chemical properties and the individual, segregated battery types are then transferred to the battery container, where batteries are cooled using CO₂ in the hot chamber of the container, while the cold chamber is used to cool the batteries using dry ice and once the batteries reach the temperature below −34° C., the batteries are crushed, the polymer film is separated pneumatically and magnetic separation of battery housing parts and sieving of the crushed material in the vibrating sieve chamber are performed and the electrode powder is recovered for further processing, wherein batteries are cooled in the battery container in a CO₂ atmosphere, in the hot chamber of the container, to which gaseous CO₂ is directed from the circulation, and subsequently, the initially cooled batteries are transferred to the cold chamber of the container, to which dry ice granules are supplied through the chute, wherein the battery storage time with dry ice granules in the cold chamber is at least 10 min, wherein dry ice granules with the diameter of 3 mm to 16 mm are supplied to the cold chamber, wherein in the first crushing step, the cutting unit, cuts the batteries with added dry ice granules into slices, 7 to 12 mm thick, and the cooled material from the first crushing step, cut into slices and mixed with dry ice, is crushed during the second crushing step in an impact mill, wherein pneumatic separation of plastic particles is performed in the impact mill, while crushing in the impact mill is performed together with dry ice particles and the milled material is obtained as a mixture of electrode material particles and particles of film present in the batteries, while gaseous CO₂ is returned to the hot chamber of the battery container, and the material obtained during crushing inside the impact mill with pneumatic separation of plastics is fed to the vibrating sieve chamber, wherein the top sieve retains the fraction of particles larger than 5 mm, at a temperature not higher than 0° C., which is subjected to pneumatic separation separating polymer particles and the residue is transferred onto the magnetic separator, where magnetic metal parts are separated, and subsequently, the residue retained on the bottom sieve is transferred to the magnetic separator, where the retained fraction contains particles with the size of 1 mm to 5 mm, where magnetic particles are again separated from the residue containing particles of cathode and anode material, together with the solidified electrolyte solution.

4. A battery fractionation method according to claim 3, wherein that batteries and dry ice granules with diameter of 3 mm to 16 mm are fed simultaneously to the cold chamber, wherein the cutting unit cuts the mixture of batteries and added dry ice granules into slices, 7 to 12 mm thick.

5. A battery fractionation method according to claim 3, wherein the rotation speed of shafts of the cutting unit with meshing knives in this device is set at 7 to 13 rotations/minute.

6. A battery fractionation method according to claim 3, wherein the rotation speed of knives of the impact mill is set at 1,000 to 2,000 rotations/minute.
